(19) United States
(12) Patent Application Publication
(10) Pub. No.: US 2026/0063981 A1
(43) Pub. Date: Mar. 5, 2026

(54) VEHICLE IMAGE PROJECTOR SYSTEM

(71) Applicant: Ford Global Technologies, LLC, Dearborn, MI (US)

(72) Inventors: Jose Ernesto Simon Gonzalez, Culiacán (MX); Misraim Lule, Cuautitlán Izcalli (MX); Juan Jose Barajas, Mexico City (MX); Jose Maria Aburto, Yautepec (MX); Edwin Osvaldo Granados Osornio, Tlalnepantla (MX)

(73) Assignee: Ford Global Technologies, LLC, Dearborn, MI (US)

(21) Appl. No.: 18/825,609

(22) Filed: Sep. 5, 2024

(51) Int. Cl. G03B 21/58; B60K 35/60

(52) U.S. Cl. CPC G03B 21/58; B60K 35/60; B60K 2360/66; B60K 2360/816

(57) ABSTRACT

A projector system for a vehicle includes a projector screen configured to be installed proximate a rear end of the vehicle or a rear cargo of the vehicle when the liftgate of the vehicle is in an open position and a projector assembly having a housing supporting an image projector. The housing has a striker configured to releasably connect to a latch on the liftgate of the vehicle such that the image projector, when assembled on the liftgate in an open position, is operable to illuminate the projector screen.

### FIELD OF THE DISCLOSURE

The present disclosure generally relates to image display systems for use on a motor vehicle, and more particularly relates to a projector system having an image projector configured for projecting images on a projector screen such as for a vehicle tailgating scenario.

### BACKGROUND OF THE DISCLOSURE

Motor vehicles increasingly are equipped with video image displays throughout the vehicle. For example, video image displays may be located within the vehicle or may be viewable at the rearend of the vehicle in a tailgating position. It may be desirable to provide for an image projector system for use in a vehicle that is easy to use.

### SUMMARY OF THE DISCLOSURE

According to a first aspect of the present disclosure, a projector system for a vehicle includes a projector screen configured to be installed proximate a rear end of the vehicle or a rear cargo area of the vehicle when the liftgate of the vehicle is in an open position and a projector assembly having a housing supporting an image projector. The housing has a striker configured to releasably connect to a latch on the liftgate of the vehicle such that the image projector, when assembled on the liftgate in an open position, is operable to illuminate the projector screen.

Embodiments of the first aspect of the present disclosure can include any one or a combination of the following features:
the projector assembly further comprises a base plate operatively coupled to the striker to support the housing in a use position;
the projector further comprises a bracket coupling the housing to the base plate;
the housing defines a compartment for receiving the image projector and one or more other items;
the projector screen has one or more connectors configured to support the projector screen on the tailgate;
the projector screen comprises at least a first projector panel and a second projector panel, wherein the first projector panel folds relative to the second projector panel;
the projector screen is operable to connect within the cargo area of the vehicle to provide a cargo cover over a portion of the cargo area;
the first and second panels fold to provide the cargo cover;
the cargo area is rearward of a rear row of seating in the vehicle; and
the striker comprises a U-shaped arm.

According to a second aspect of the present disclosure, a vehicle has a cargo area forward of a rear end, a liftgate at the rear end and a projector system. The projector system includes a projector screen configured to be installed proximate the rear end or the rear cargo area when the liftgate of the vehicle is in an open position and a projector assembly having a housing supporting an image projector. The housing has a striker configured to releasably connect to a latch on a liftgate of the vehicle such that the image projector, when assembled on the liftgate in an open position, is operable to illuminate the projector screen.

Embodiments of the second aspect of the present disclosure can include any one or a combination of the following features:
the projector assembly further comprises a base plate operatively coupled to the striker to support the housing in a use position;
the projector further comprises a bracket coupling the housing to the base plate;
the housing defines a compartment for receiving the image projector and one or more other items;
the projector screen has one or more connectors configured to support the projector screen on the tailgate;
the projector screen comprises at least a first projector panel and a second projector panel, wherein the first projector panel folds relative to the second projector panel;
the first and second panels fold to provide the cargo cover;
the projector screen is operable to connect within the cargo area of the vehicle to provide a cargo cover over a portion of the cargo area;
the cargo area is rearward of a rear row of seating in the vehicle; and
the striker comprises a U-shaped arm.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1 is a schematic sideview of a motor vehicle with an image projector system having a deployable display screen and projector assembly supported by an open liftgate, according to one example;

FIG. 2 is a rear perspective view of a rear end of a motor vehicle with the liftgate in an open position and the projector screen in a rear viewing position illuminated by a projector at the rear end of a motor vehicle;

FIG. 3A is a schematic side view of the rear portion of the vehicle showing the projector screen configured as a rear cargo area cover;

FIG. 3B is a schematic side view of the rear end of the vehicle showing partial deployment of the projector screen during opening of the liftgate;

FIG. 3C is a schematic side view of the rear end of the vehicle illustrating further deployment of the projector screen during opening of the liftgate;

FIG. 3D is a schematic side view of the rear end of the vehicle illustrating full deployment of the projector screen and assembly of the projector assembly on a latch of the liftgate;

FIG. 4 is an elevated perspective view of the projector screen shown in the deployed use position;

FIG. 5 is an exploded perspective view of the projector screen shown in FIG. 4 in the deployed use position;

FIG. 6 is a front perspective view of the projector assembly having a mount assembly with a striker for connection to the latch on the liftgate; and

FIG. 7 is a rear perspective view of the projector assembly shown in FIG. 6.

### DETAILED DESCRIPTION OF PREFERRED EMBODIMENTS

Reference will now be made in detail to the present preferred embodiments of the disclosure, examples of which are illustrated in the accompanying drawings. Wherever possible, the same reference numerals will be used throughout the drawings to refer to the same or like parts. In the drawings, the depicted structural elements are not to scale and certain components are enlarged relative to the other components for purposes of emphasis and understanding.

As required, detailed embodiments of the present disclosure are disclosed herein; however, it is to be understood that the disclosed embodiments are merely exemplary of the disclosure that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present disclosure.

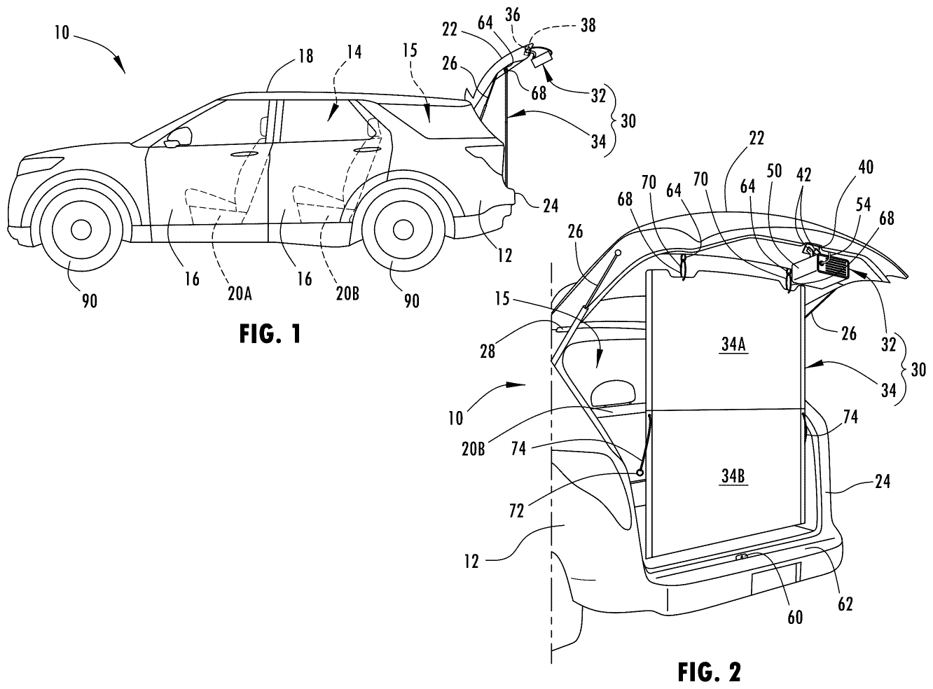

For purposes of description herein, the terms “upper,” “lower,” “right,” “left,” “rear,” “front,” “vertical,” “horizontal,” and derivatives thereof shall relate to the concepts as oriented in FIG. 1. However, it is to be understood that the concepts may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

The present illustrated embodiments reside primarily in combinations of method steps and apparatus components related to an image projector system for a vehicle. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

As used herein, the term “and/or,” when used in a list of two or more items, means that any one of the listed items can be employed by itself, or any combination of two or more of the listed items, can be employed. For example, if a composition is described as containing components A, B, and/or C, the composition can contain A alone; B alone; C alone; A and B in combination; A and C in combination; B and C in combination; or A, B, and C in combination.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about. ” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

As used herein the terms “the,” “a,” or “an,” mean “at least one,” and should not be limited to “only one” unless explicitly indicated to the contrary. Thus, for example, reference to “a component” includes embodiments having two or more such components unless the context clearly indicates otherwise.

Referring to FIGS. 1 and 2, a wheeled automotive or motor vehicle 10 is generally illustrated configured with passenger seating for transporting one or more passengers on board the motor vehicle 10. The motor vehicle 10 has a plurality of road wheels 90 and a vehicle body 12 that generally defines a passenger cabin 14. The passenger cabin has a seating area and a rear cargo area 15 generally located rearward of the seating area. The vehicle body 12 generally includes body panels, side entry doors 16, a roof 18 and a rear liftgate 22 that serves as a rear end access door that moves to an open position to access the rear cargo area.

The passenger cabin 14 is shown having an arrangement of front row passenger seats 20A, which typically may include a driver's seat and a passenger's seat. The motor vehicle 10 is also illustrated having additional seating in a second row of seating as shown by seat 20B which is in the seating area. The second row of seating is located vehicle rearward of the first row of seating. The motor vehicle 10 may include additional rows of seating as is common for a large van or bus, for example. It should be appreciated that the motor vehicle 10 may be a motor vehicle such as a wheeled car, truck, SUV, van or bus, for example, having a rear liftgate to accommodate a tailgating area and outdoor cinema projector system.

Located behind the rear row of seating 20B, is the cargo area 15 which extends towards the rear end 24 of the motor vehicle 10. The liftgate 22 may close the cargo area 15 in the closed position and may expose the cargo area in the open position such as is shown in FIGS. 1 and 2. When the liftgate 22 is configured in the open position, the motor vehicle 10 may be configured with an image projector system 30 to provide an outdoor viewing cinema with a projector screen 34 that displays projected light images that are generated by a projector assembly 32 and illuminated onto the vehicle rearward surface of the projection screen 32. Hence, the projected illuminated images are viewable on the projector screen 34 from outside the motor vehicle 10 looking forward towards the rear end 24 of the motor vehicle 10 from behind the motor vehicle 10. The use of the outdoor viewing cinema may be particularly advantageous in a vehicle tailgating scenario.

The liftgate 22 is moveable between the closed position closing off rear end access to the rear cargo area 15 and the open position exposing the rear cargo area as seen in FIGS. 1 and 2. The liftgate 22 has one or more hinges 28 generally positioned along an upper edge of the liftgate 22 and connected to the vehicle body at the rear end 24 below the roof 18 of the vehicle 10. The hinges 28 allow the liftgate 22 to rotate between the open and closed positions. In addition, a pair of actuator mechanisms 26, shown as telescoping tubes, are shown extending between the vehicle body 12 and the liftgate 22 to actuate the liftgate 22 between the open and closed positions. It should be appreciated that the liftgate 22 may be actuated via a motor or may be manually actuated.

The motor vehicle 10 has a door sill 62 generally extending laterally at the rear end generally above a bumper and just rearward of the cargo area 15. The door sill 62 generally defines the lower surface of the opening receiving the liftgate 22 in the closed position. A liftgate striker 60 is located within the door sill 62 extending upwards and is configured to engage a latch 36 at the rear or lower end of the liftgate 22 to latch closed the liftgate 22 in the closed position. With the liftgate 22 in the open position, the latch 36 in the liftgate 22 is exposed at an elevated rearward extending open position as is seen in FIG. 2. In this open position, a projector assembly 32 having a projector striker 38 may engage and connect onto the latch 36 to hold the projector assembly 32 in a use position. The projector assembly 32 has an image projector configurable to generate video images that may be projected for display on the projector screen 34.

The projector screen 34 has upper and lower panels 34A and 34B shown deployed as a screen extended in a plane and held onto a pair of connector hangers 64 such as hooks on the inner wall of the liftgate 22 via a pair of connector loops 68 at the top end of the projector screen 34, according to one example. In addition, the projector screen 34 may be connected to connectors in the vehicle cargo area 15 via connector straps 74 shown having connector ends 72. Accordingly, the projector screen 34 may extend substantially vertically hanging from the liftgate 22 proximate the rear end 24 or cargo area 15 when the liftgate 22 is in the open position and may be stably supported via the connector loops 68 and connector straps 74.

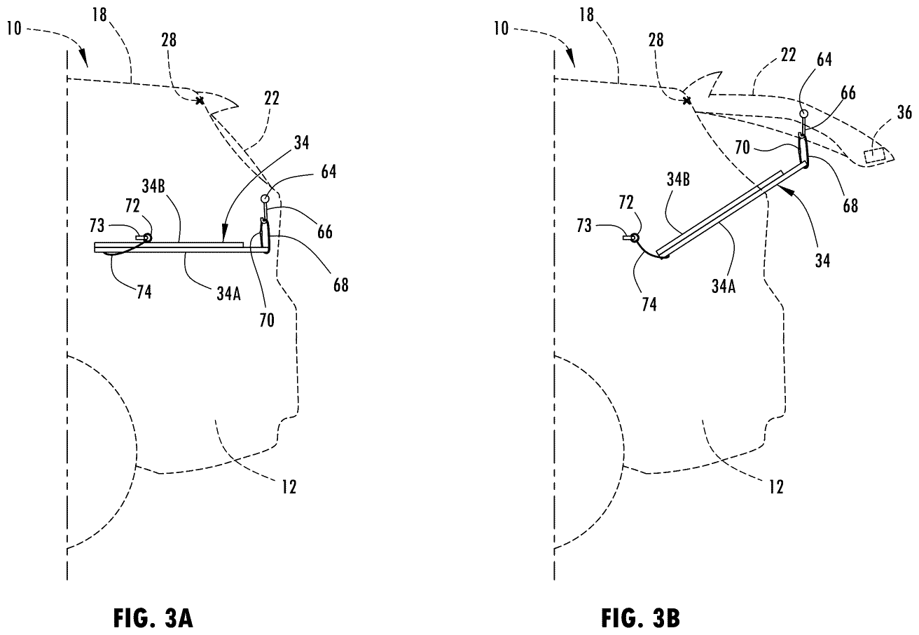

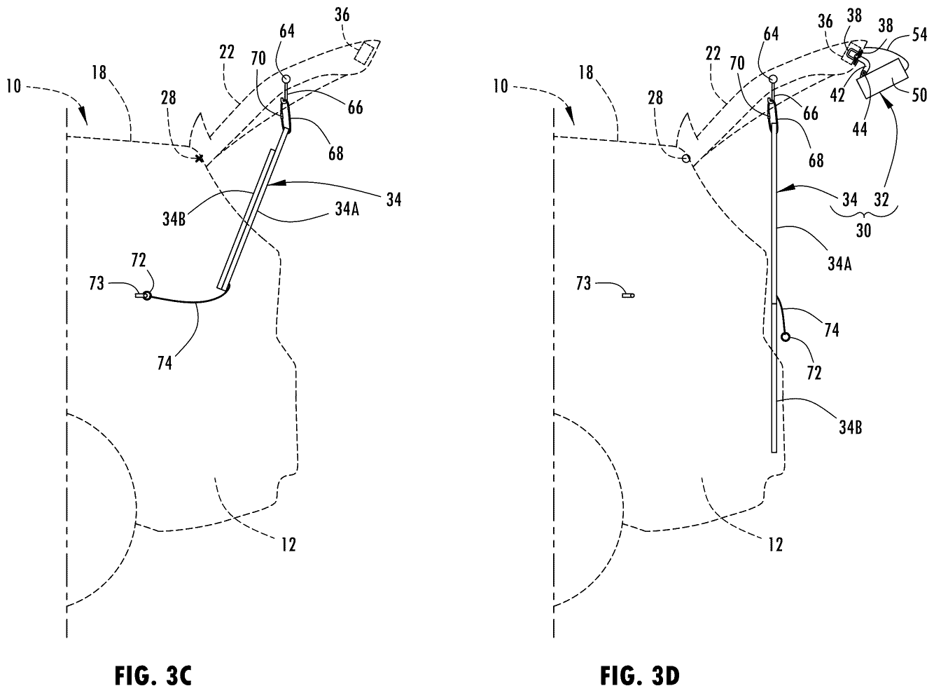

Referring to FIGS. 3A-3D, the motor vehicle 10 is shown having the projector screen 34 moveable between a cargo cover configuration with the liftgate 22 in the close position positioned as shown in FIG. 3A and a projector screen configuration with the liftgate 22 in the open position positioned as shown in FIG. 3D. As seen in FIG. 3A, the projector screen 34 in the cargo cover configuration is in a folded configuration with the upper and lower panels 34A and 34B folded in parallel planes and generally held horizontal and elevated within the cargo area 15 and extending between the liftgate 22 and the rear row of seating. In this position, the projector screen 34 may cover cargo in the cargo area located below the projector screen 34 and readily kept out of view.

As seen in FIG. 3B, the liftgate 22 may be unlatched by unlatching the liftgate striker 60 from the latch 36 and rotated upward about hinges 28 via actuator arms 26 to an open position. In doing so, the projector screen 34 may be rotated partially upward at an angle and to a position as seen in FIG. 3C. With the liftgate 22 in the fully open position, the pair of connector straps 74 may be disconnected from a pair of connectors 73 in the cabin, and the projector screen 34 may be unfolded to an extended position as seen in FIG. 3D which extends generally vertically downward. In this position, the projector assembly 32 may be oriented to project images onto the projector screen 34 for viewing by one or more users outside of the vehicle 10 while looking vehicle forward at the rear end 24 from rearward of the motor vehicle 10.

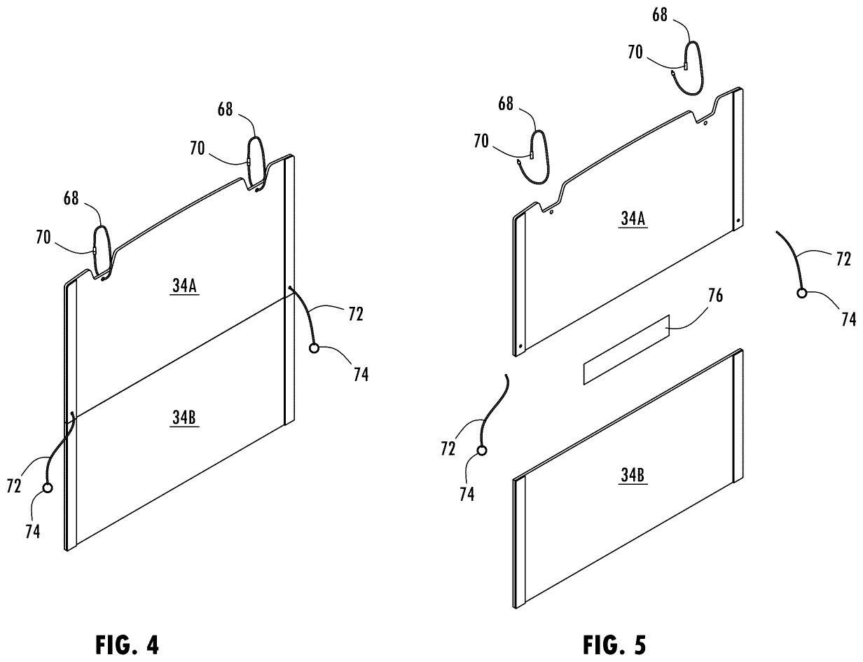

Referring to FIGS. 4 and 5, the projector screen 34 is shown having the upper panel 34A hingedly connected to a lower panel 34B. The upper panel 34A is connected to the lower panel 34B via one or more hinges 76 such that the upper and lower panels 34A and 34B may be folded in the folded configuration relative to another or extended into the planer configuration as seen in FIG. 4.

The projector screen 34 has a pair of connector loops 68 at the top end thereof for hanging the projector screen 34 from hangers 64 on the liftgate 22. The connector loops 68 may include connector members 70 which allow for a disconnect in the loop to attach onto the upper panel 34A and hangers 64. In addition, the projector screen 34 has the pair of flexible connector arms 72 each with connector loops 74 for holding the projector screen 34 in the cargo cover position.

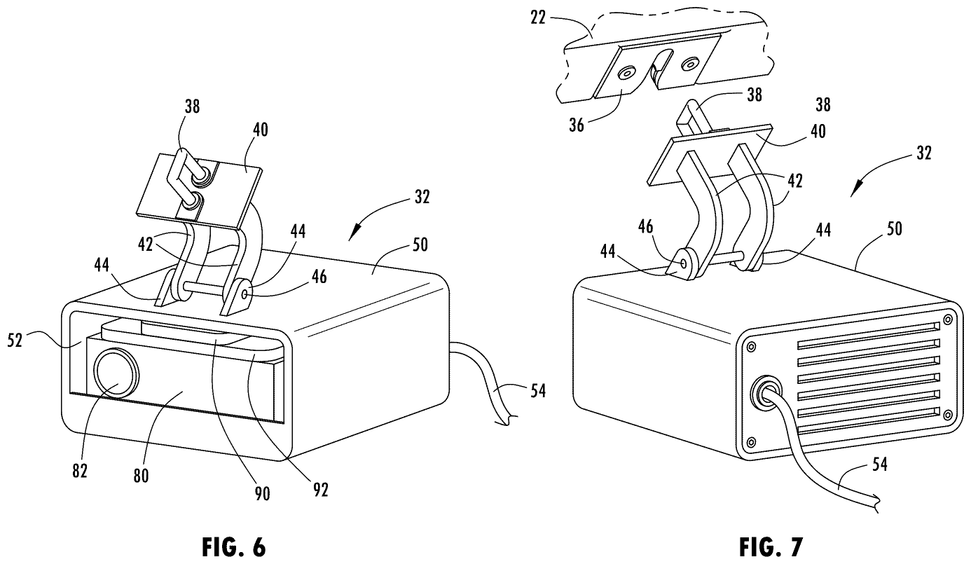

Referring to FIGS. 6 and 7, the projector assembly 32 is illustrated, according to one example. The projector assembly 32 includes a housing 50 which generally defines a compartment 52. In the example shown, the housing 50 is generally rectangular and the compartment 52 is generally rectangular. Located within the compartment 52 and exposed at an open end 82 is an image projector 80. The image projector 80 is configured to generate illuminated images onto the projector screen. This may include photos, video messages and other projections of illuminated images. The projector assembly 32 may include any known image projector.

The projector assembly 32 includes a bracket 44 mounted on the upper side of housing 50 and configured to connect to a pair of arms 42 via a pivot pin 46. As such, the arms 42 may be adjusted to rotate relative to the bracket 44 to adjust the position or orientation of the housing 50 and thus the alignment of the image projector 80 and hence the projector output beam. The pair of arms 42 in turn are connected to the support plate 40 which has the projector striker 38 extending therefrom. The projector striker 38 may be a bent arm in a U-shape such as a rod. Accordingly, the projector striker 38 may be inserted into the latch 36 on the liftgate 22 of the vehicle 10 to releasably connect to the latch 36 to enable the image projector 80 to be optically aligned with the projector screen 34. The image projector 80 may receive power such as from a power/communication cable 54. Communication of data such as video images and related data may be supplied over the power/communication cable 54 or may be provided via wireless communication.

Accordingly, the projector system 30 advantageously allows for images such as video images to be displayed with a projector screen 34 by a projector assembly 32 in a manner that is easy to use to enable outdoor viewing of video images from a position rearward of the motor vehicle 10 looking towards the rear end 24 of the motor vehicle 10. The projector 30 is easy to assemble and disassemble. It should be appreciated that the motor vehicle 10 should be locked-out in park and not moving while the projection system 30 is assembled as a cinema on the motor vehicle 10.

It is to be understood that variations and modifications can be made on the aforementioned structure without departing from the concepts of the present disclosure, and further it is to be understood that such concepts are intended to be covered by the following claims unless these claims by their language expressly state otherwise.

What is claimed is:

1. A projector system for a vehicle, the projector system comprising:
a projector screen configured to be installed proximate a rear end of the vehicle or a rear cargo area of the vehicle when the liftgate of the vehicle is in an open position; and
a projector assembly having a housing supporting an image projector, wherein the housing has a striker configured to releasably connect to a latch on the liftgate of the vehicle such that the image projector, when assembled on the liftgate in an open position, is operable to illuminate the projector screen.

2. The projector system of claim 1, wherein the projector assembly further comprises a base plate operatively coupled to the striker to support the housing in a use position.

3. The projector system of claim 2, wherein the projector further comprises a bracket coupling the housing to the base plate.

4. The projector system of claim 1, wherein the housing defines a compartment for receiving the image projector and one or more other items.

5. The projector system of claim 1, wherein the projector screen has one or more connectors configured to support the projector screen on the tailgate.

6. The projector system of claim 1, wherein the projector screen comprises at least a first projector panel and a second projector panel, wherein the first projector panel folds relative to the second projector panel.

7. The projector system of claim 6, wherein the projector screen is operable to connect within the cargo area of the vehicle to provide a cargo cover over a portion of the cargo area.

8. The projector system of claim 7, wherein the first and second panels fold to provide the cargo cover.

9. The projector system of claim 8, wherein the cargo area is rearward of a rear row of seating in the vehicle.

10. The projector system of claim 1, wherein the striker comprises a U-shaped arm.

11. A vehicle comprising:
a cargo area forward of a rear end;
a liftgate at the rear end; and
a projector system comprising:
a projector screen configured to be installed proximate the rear end or the rear cargo area when a rear door of the vehicle is in an open position; and
a projector assembly having a housing supporting an image projector, wherein the housing has a striker configured to releasably connect to a latch on a liftgate of the vehicle such that the image projector, when assembled on the liftgate in an open position, is operable to illuminate the projector screen.

12. The vehicle of claim 11, wherein the projector assembly further comprises a base plate operatively coupled to the striker to support the housing in a use position.

13. The vehicle of claim 12, wherein the projector further comprises a bracket coupling the housing to the base plate.

14. The vehicle of claim 11, wherein the housing defines a compartment for receiving the image projector and one or more other items.

15. The vehicle of claim 11, wherein the projector screen has one or more connectors configured to support the projector screen on the tailgate.

16. The vehicle of claim 11, wherein the projector screen comprises at least a first projector panel and a second projector panel, wherein the first projector panel folds relative to the second projector panel.

17. The vehicle of claim 16, wherein the first and second panels fold to provide the cargo cover.

18. The vehicle of claim 17, wherein the projector screen is operable to connect within the cargo area of the vehicle to provide a cargo cover over a portion of the cargo area.

19. The vehicle of claim 18, wherein the cargo area is rearward of a rear row of seating in the vehicle.

20. The vehicle of claim 11, wherein the striker comprises a U-shaped arm.
